(19) United States
(12) Patent Application Publication
(10) Pub. No.: US 2019/0379076 A1
(43) Pub. Date: Dec. 12, 2019

(54) HYBRID SEAL AND PLANAR ARRANGEMENT COMPRISING AT LEAST ONE HIGH TEMPERATURE ELECTROCHEMICAL CELL AND A HYBRID SEAL

(71) Applicant: SOLIDpower SA, Yverdon-les-Bains (CH)

(72) Inventors: Zacharie WUILLEMIN, Cully (CH); Yannik ANTONETTI, Pully (CH)

(73) Assignee: SOLIDpower SA, Yverdon-les-Bains (CH)

(21) Appl. No.: 16/334,117

(22) PCT Filed: Sep. 16, 2016
(86) PCT No.: PCT/IB2016/055552

§ 371 Date: Mar. 18, 2019

(51) Int. Cl. H01M 8/1213; H01M 8/00; H01M 8/0258; H01M 8/2432; C25B 9/18; H01M 8/0276

(52) U.S. Cl. CPC H01M 8/1213; H01M 8/006; H01M 8/0258; H01M 2008/1293; C25B 9/18; H01M 8/0276; H01M 8/2432

(57) ABSTRACT

The planar arrangement having CAE-unit, both a first flow field for an oxidizing gas and a first interconnect arranged on a first side of the CAE-unit, both a second flow field for a combustible gas and a second interconnect arranged on the other side of the CAE-unit, the CAE-unit having a first and a second electrode layer, and a solid electrolyte sandwiched therebetween. The first electrode layer forming the first side of the CAE-unit and the second electrode layer forming the other side. Further including a circumferential sealing member to prevent either the leakage of oxidizing gas or combustible gas to the environment or the mixing of the two gases. The sealing member includes a glass component bound to the upper surface of the second interconnect, and a sheet of ceramic fiber paper or mica arranged so as to cover a side of the glass component facing the first interconnect.

### FIELD OF THE INVENTION

According to a first aspect, the present invention is directed to a planar arrangement comprising at least one high temperature planar electrochemical cell comprising a first electrode layer, a second electrode layer, a solid electrolyte sandwiched between the first and the second electrode layer, both a first flow field for an oxidizing gas and a first interconnect comprising a current collector layer arranged on the same side of the solid electrolyte as the first electrode layer, both a second flow field for a combustible gas and a second interconnect comprising a current collector layer arranged on the same side of the solid electrolyte as the second electrode layer, and a circumferential sealing member provided in order to prevent the leakage of the oxidizing gas or of the combustible gas to the environment or to prevent any substantial mixing of said two gases. According to a second aspect, the invention is directed to a sealing member for a planar arrangement comprising at least one high temperature planar electrochemical cell.

### BACKGROUND OF THE INVENTION

Planar arrangements comprising at least one high temperature planar electrochemical cell corresponding to the definition given above are known. Such electrochemical-cell arrangements exhibit the general shape of a thin plate or planar slab, and they comprise at least one electrochemical cell intended for use either as an electrolyzer cell or as a fuel cell. Known planar arrangements of the type just described usually only comprise a single electrochemical cell. However, patent document U.S. Pat. No. 5,952,116, for example, discloses a large planar arrangement comprising a plurality of electrochemical cells electrically connected in parallel. It should be understood however, that even in the case of such large planar arrangements, the total volume of the cells comprised in a single planar arrangement is relatively small. Therefore, in order to obtain outputs at acceptable costs, individual planar arrangements are normally stacked one over the other and connected electrically in series. The structure formed by a number of planar arrangements stacked one over the other is called a stack (a fuel cell stack or an electrolyzer stack).

In the more common case wherein the individual stacking units making up a stack are planar arrangements essentially in the form of a single electrochemical cell, the individual stacking units each consist of two major components, a cathode-anode-electrolyte-unit (CAE-unit) forming the innards of the electrochemical cell, and an interconnect, having the form of a cassette in some cases. The interconnect comprises a current collector on either side, and the two current collectors are connected electrically to each other. This last feature provides an electrical connection between the CAE-unit of one planar arrangement and the CAE-unit of the next planar arrangement, so that the electrical voltages of each one of the CAE-units add up. Each interconnect also defines a first flow field to transport an oxidizing gas to an electrode of the electrochemical cell of one planar arrangement, and a second flow field to transport a combustible gas to an electrode of the electrochemical cell of the next planar arrangement.

Such stack-reactors typically have at least one seal member arranged around the periphery of each CAE-unit to isolate and/or separate the gases fed to or led away from the electrodes. Insufficient sealing could lead to direct combustion of fuel gases, and hence result in loss in efficiency, malfunctioning of stack components or even in the complete failure of the stack. Seals for such reactors must maintain operating integrity in a wide range of oxygen partial pressure (air and fuel) while minimizing thermal stresses during high temperature operation and thermal cycling.

In the alternative case where the planar arrangements making up a stack comprise a plurality of electrochemical cells, each planar arrangement comprises several CAE-units arrayed in the same plane. In this case, the stack-reactors may also have additional seal members arranged between the different CAE-units of an individual planar arrangement.

Many sealant options can be found in prior art, either being rigid or compressive. A major advantage of compressive seals is that the seals are not rigidly fixed to the other components of the high temperature electrochemical reactor, thus the exact match of thermal expansion is not required. This also has a downside, being that mechanical load must be applied continuously during operation. Compressible seals are normally metal gaskets, ceramic felt, ceramic paper, or mica-based materials. Rigid seals, on the other hand, do not require the continuous load, but the thermal expansion must closely match those of the other stack components. Rigid seals are typically glasses and glass ceramics. Metallic brazes are also used as rigid seals. The challenges of metallic brazes are cost and their wetting behavior of the ceramic components. The use of fluxes to improve wetting is problematic as it easily spreads through the stack during operation and harms other stack components.

Among the above sealing options, sealants based on partially crystallizing glass (hereafter called glass ceramics) are the most promising solution. They are formed as a glass, and then are partially crystallized by heat treatment. In general, glasses and partially crystallized glass ceramics possess a transition temperature, above which the material changes from a rigid, brittle state to a ductile behavior, which is needed to provide sufficient viscous flow and thus adequate sealing. However, the sealing material should not become too fluid as it can flow out from between the joining partners and hence result in open gaps and subsequent leakage. In addition, sufficient rigidity is crucial for maintaining mechanical integrity.

The operating temperatures of high temperature electrochemical reactors can typically vary from 500 to 1000° C., depending on the components used for the interconnectors which are used in the stack and on the design of the electrochemical reactors. This can require maximum joining temperatures using glass ceramic sealants of above 1000° C. When the joining temperature is reached, the glass must have sufficiently low viscosity to ensure good bonding to the metallic and ceramic joining partners. Furthermore, the glass phase portion must be sufficiently large to allow for sufficient flow of the glass. In order to set the required thermal coefficient of expansion (CTE), crystal phases that crystallize out during or after joining should have correspondingly high CTE. The crystal phases should further not change significantly in composition or proportion within the service life of the reactor to avoid any change in properties of the glass. In addition, the glass should have good chemical compatibility with the joining partners and high stability in dual atmospheres.

Glass ceramics that are frequently used for high temperature electrochemical reactors such as solid oxide fuel cells (SOFC) are typically composed of a mixture of SiO2, Al2O3, BaO, CaO, and B2O3, and are called barium calcium alumino-silicate glasses. Such glasses provide a better combination of chemical compatibility and stability properties than phosphate- or borate-based glasses. The advantages of this type of glasses over other glass sealants for high temperature electrochemical reactors have been recognized by many researchers, many of which have protected their preferred compositions by patents. There are, however, some issues with those glasses regarding their long term stability. The most prominent ones are discussed hereafter.

Experience teaches that the fracture toughness of glass-ceramic seals inevitably decreases with time. Furthermore, the adherence of such seals to metal surfaces also weakens with time. It follows that the likelihood of such seals either breaking or delaminating increases with time. As a first point, the inventors propose, without any intention of being bound by theory, that upon cooling from the glass curing temperature to the nominal operating temperature, crystallization in the barium calcium alumino-silicate glass is slowed down but does not stop. This continuing devitrification causes the volume fraction of the ceramic crystalline phase in the sealant material to increase over time during periods when the electrochemical cell is held at its operating temperature. Furthermore, the rearrangement of atoms due to the prolonged devitrification may trigger the formation of voids and cracks. Hence devitrification changes the mechanical properties and gas tightness of the sealant. Particularly problematic with regard to devitrification under practical circumstances is the diffusion of cations released by the metal parts of the stack that are adjacent to the glass seal. In presence of an electric field, which is typical for high temperature electrochemical reactors, those cations have the tendency to travel through the sealant. Upon reaction between the cations and the glass, the physicochemical properties of the glass change, which in its turn triggers the formation of crystalline phases.

A second point made by the inventors, concerns the release of chromium from the adjacent steel. It has been found that Cr ions released by the adjacent metal react with Ba ions in the glass to form BaCrO4. Upon operation, the amount of BaCrO4 that forms at the interface between the metal and the glass sealant increases. And because BaCrO4 has a CTE that is substantially different from that of the metal or the glass seal, the sealant becomes more prone to mechanical failure and delamination. Also volatile Cr species such as chromium oxide and chromium oxy-hydroxide, which may form at the metal surface in the vicinity of the glass seal, may react with the glass to form BaCrO4. In fact, the impact of volatile chromium compounds would get more and more important upon long term operation, as the amount of defects in the glass increases and the volatile species more easily find their way into the glass bulk.

As a third point, the inventors propose that another cause of the problems associated with the use of barium calcium alumino-silicate glasses is the volatilization of boron. Boron is added to the glass in order to lower the glass transformation temperature, which is needed to cure the glass sealant at temperatures that are acceptable for the other stack components. It is known that the rate of volatilization increases dramatically with increasing partial pressure of water vapor surrounding the glass at constant temperature and with increasing glass temperature at constant partial pressure of water vapor. The volatilization of boron is particularly problematic because it forms gas bubbles inside the glass, which weakens the mechanical properties of the glass. It has been found by the inventors and other researchers that pore formation that is likely related to boron volatilization is particularly problematic in glass seals that are exposed to dual atmosphere, i.e. exposed to oxidant at one side and exposed to fuel at the other side. This is possibly related to the place in the glass seal where formation of steam most likely occurs. The steam may form by chemical reaction of hydrogen that diffuses through the glass from the fuel side of the sealant, and oxygen gas that diffuses through the glass from the oxidant side.

Long term stability is not the only issue with glass ceramic seals. In particular, it is known in the field of high temperature electrochemical cells that glass sealing members shrink considerably during the first curing of the glass sealant material. Furthermore, in many cases, a fraction of the sealant material flows into gaps or micro irregularities in the surfaces of the joining partners. As a result, the thickness of the seal after the first curing is considerably less than the original thickness. Therefore, in order to prevent the formation of gaps or holes in the seal, a large compressive load is usually applied onto the stack assembly during curing of the seals. Accordingly, one will understand that, as curing reduces the thickness of the seals, the height of the stack is also substantially reduced.

The change of the height of the stack is a problem because the other components of the stack generally do not exhibit the same shrinking behavior as the glass sealing members. Sizing and shaping the different components of the fuel cell in such a way as to obtain a good fit once the structure has been cured can prove challenging.

### SUMMARY OF THE INVENTION

It is therefore an object of the present invention to solve the above-mentioned problems of prior art sealing members for planar arrangements comprising at least one high temperature electrochemical cell. According to a first aspect, the present invention achieves this object by providing a planar arrangement according to the annexed claim 1.

One advantage of the invention is that the sheet of ceramic flake paper or ceramic fiber paper (referred to from now on as ceramic flake or fiber paper) is capable of expanding in the thickness direction in order to compensate for the shrinkage of the glass component. In this way, it is possible to carry out curing of the sealing member with minimal change in the overall height of the high temperature planar electrochemical cell. This feature considerably simplifies the job of designing the components of the electrochemical cell, as well as the sintering process requirements.

Another advantage of the invention stems from both the low in-plane shear strength and out-of-plane tensile strength of the sheet of ceramic fiber or flake paper. Indeed, even a relatively small difference in the thermal coefficient of expansion or the temperature profiles of the joining partners can cause shear or tensile stress. Due to its low shear and tensile strength, the sheet of ceramic fiber or flake paper can absorb the shear or tensile stress between the joining partners, and thus protect the glass component of the sealing member.

Still another advantage of the invention is that the sheet of ceramic fiber or flake paper can protect the glass from chemicals. Indeed, it can be observed that the air or gas in the flow field for oxidizing gas is contaminated by chemicals (in particular large quantities of volatile chromium). As the sheet of ceramic fiber or flake paper is arranged on the oxidizing gas side of the sealing member (the side facing the first interconnect), it lies between the contaminated oxidizing gas and the glass component.

According to a favorable embodiment of the invention, a spacer is provided between the sheet of ceramic flake or fiber paper and the first interconnect in such a way that the sheet of ceramic flake or fiber paper is pressed against the glass component by the first interconnect. An advantage of this arrangement is that the spacer can serve to further mechanically decouple the first and the second interconnect. Indeed, although the interconnects are usually made from the same material and thus have the same thermal coefficient of expansion, any thermal gradient along the length of the stack can cause thermal stress if the interconnects are fixed one to the other.

According to a preferred variant of the above-mentioned favorable embodiment, a compressive load is applied axially to the stack and the spacer is designed in such a way that the resultant compressive force that acts on the sealing member is less than the resultant compressive force that acts on the active part of the electrochemical cell.

According to another favorable embodiment of the invention, the glass component surrounds the solid electrolyte, and the sheet of ceramic flake or fiber paper covers both the glass component and an outer part of the solid electrolyte. According to a preferred variant of this favorable embodiment, a thin layer of glass is sandwiched between the sheet of ceramic flake or fiber paper and the surface of the outer part of the solid electrolyte.

According to another favorable embodiment of the invention, the top surface of the second interconnect carries a peripheral rim that surrounds the glass component of the sealing member. According to a first variant of this embodiment, the rim is formed by a peripheral protruding part of the upper surface of the second interconnect. According to an alternative second variant, the rim is formed by a separate part in the form of a frame or of a wire that is mounted on the upper surface of the second interconnect. An advantage of having a rim around the sealing member, is that the rim can constrain the glass component during curing. According to a preferred implementation of this embodiment, the sheet of ceramic flake or fiber paper also covers the rim, an optional thin layer of glass possibly being sandwiched between the sheet of ceramic flake or fiber paper and the rim.

According to still another favorable embodiment of the invention, the sheet of ceramic flake or fiber paper is a mica containing sheet. Furthermore, the mica contained in the sheet is preferably in the form of flakes.

### BRIEF DESCRIPTION OF THE DRAWINGS

Other features and advantages of the present invention will appear upon reading the following description, given solely by way of non-limiting example, and made with reference to the annexed drawings, in which:

FIG. 1 is a schematic partial cross-sectional view of a planar arrangement according to a first embodiment of the invention;

FIG. 2 is a schematic partial cross-sectional view of a planar arrangement according to a second embodiment of the invention;

FIG. 3 is a schematic partial cross-sectional view of a planar arrangement according to a third embodiment of the invention;

FIG. 4 is a schematic partial cross-sectional view of a planar arrangement according to a fourth embodiment of the invention;

FIG. 5 is a schematic partial cross-sectional view of a planar arrangement according to a fifth embodiment of the invention;

FIG. 6 is a schematic partial cross-sectional view of a planar arrangement according to a sixth embodiment of the invention;

FIG. 7 is a schematic partial cross-sectional view of a planar arrangement according to a seventh embodiment of the invention;

FIG. 8 is a schematic partial cross-sectional of a stack comprising three identical planar arrangements according to the seventh embodiment of the invention; the planar arrangements being piled one over the other;

FIGS. 9 and 10 are perspective views of two planar arrangements according to particular embodiments of the invention, the planar arrangements both comprising three high temperature electrochemical cells arranged in a row; FIG. 9 more particularly showing a single mica sheet with three rectangular cut-outs above the CAE-units; and FIG. 10 more particularly showing three individual mica paper frames, each surrounding one of the CAE-units;

FIG. 11 is a schematic partial cross-sectional of a stack comprising three identical planar arrangements according to an eighth embodiment of the invention; the planar arrangements being piled one over the other;

FIG. 12 is a schematic partial cross-sectional view of a planar arrangement according to the eighth embodiment of the invention, the partial cross-sectional view showing in particular a seal member arranged between two neighboring CAE-units of the same planar arrangement;

FIG. 13 is a schematic partial cross-sectional view similar to the view of FIG. 12 and showing a planar arrangement according to a ninth embodiment of the invention;

FIG. 14 is a schematic partial cross-sectional view similar to the view of FIG. 12 and showing a planar arrangement according to a tenth embodiment of the invention;

FIG. 15 is a schematic partial cross-sectional view similar to the view of FIG. 12 and showing a planar arrangement according to an eleventh embodiment of the invention;

FIG. 16 is a schematic partial cross-sectional view similar to the view of FIG. 12 and showing a planar arrangement according to a twelfth embodiment of the invention;

FIG. 17 is a schematic partial cross-sectional view similar to the view of FIG. 12 and showing a planar arrangement according to a thirteenth embodiment of the invention;

FIG. 18 is a schematic partial cross-sectional view similar to the view of FIG. 12 and showing a planar arrangement according to a fourteenth embodiment of the invention;

### DETAILED DESCRIPTION OF EXEMPLARY EMBODIMENTS

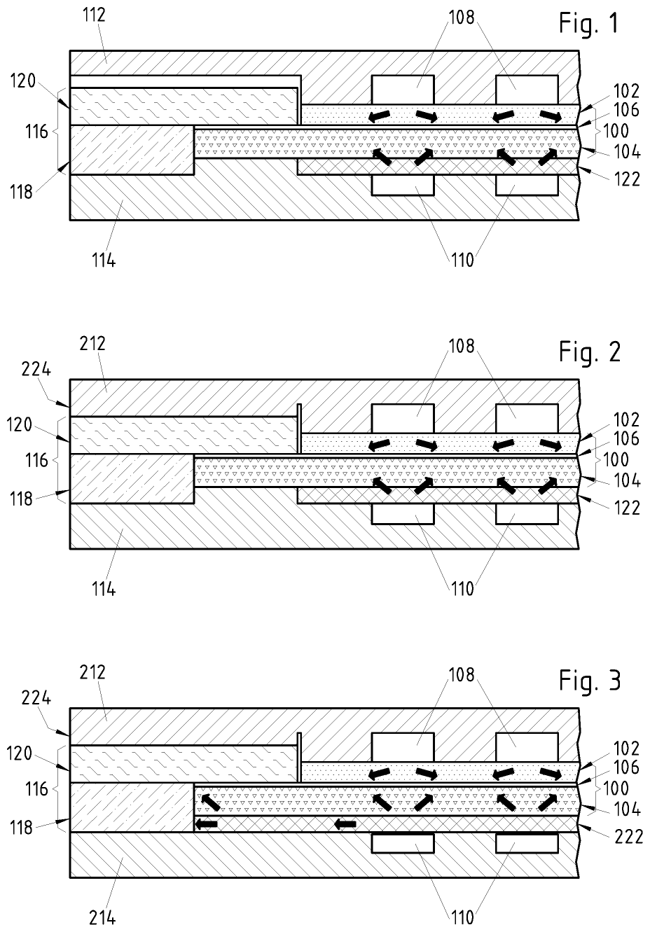

FIGS. 1 to 18 show different embodiments of the invention. Elements in different embodiments that are the same or that are functionally equivalent are usually referred to using the same reference number in the different figures. In the following description, the expressions “upper side” and “lower side” refer respectively to the upper and lower sides of parts of electrochemical cells as they are shown in the appended figures. Accordingly, the verb “to cover” should be understood as meaning “to extend over the upper side”.

According to different embodiments, the high temperature electrochemical cell or cells forming part of the planar arrangement of the invention can be designed for various applications such as electrolysis or the direct conversion of fuel into electricity. In this context, the invention is directed in particular to solid oxide steam electrolysis cells and to solid oxide fuel cells (SOFC). The annexed FIGS. 1 to 8 are schematic partial cross-sectional views of a first series of exemplary embodiments, wherein the planar arrangement of the invention essentially consists in a single solid oxide fuel cell (SOFC). The SOFCs shown in FIGS. 1 to 8 each comprise a first electrode layer or cathode 102, a second electrode layer or anode 104, a solid electrolyte 106 sandwiched between the anode and the cathode, a first flow field 108 for an oxidizing gas, a second flow field 110 for a combustible gas, and two interconnects, numbered 112 or 212 and 114 or 214 respectively.

It should be understood that any one of the individual planar arrangements illustrated in FIGS. 1 to 8 can constitute an exemplar from a set of identical stacking units arranged to form a stack comprising many such planar arrangements connected together. The appended FIG. 8 contains a partial cross-sectional view of such a stack. The partial view shows three identical planar arrangements piled one over the other. As already mentioned in relation to the prior art, the individual stacking units (generally referenced 1) each consist of two major components, a cathode-anode-electrolyte-unit (CAE-unit) 100 forming the innards of the electrochemical cell, and an interconnect 50. The upper and lower sides of the interconnect form two current collectors electrically connected to each other. The interconnects 50 thus provide an electrical connection between the CAE-unit 100 of one planar arrangement and the CAE-unit 100 of the next planar arrangement. Each interconnect also defines a first flow field 108 to transport an oxidizing gas to an electrode of the electrochemical cell of one planar arrangement, and a second flow field 110 to transport a combustible gas to an electrode of the electrochemical cell of the next planar arrangement. Accordingly, It should be understood that, as is well known in the art, each interconnect 50 is shared by two neighboring planar arrangements, and that each planar arrangement comprises an interconnect on either side.

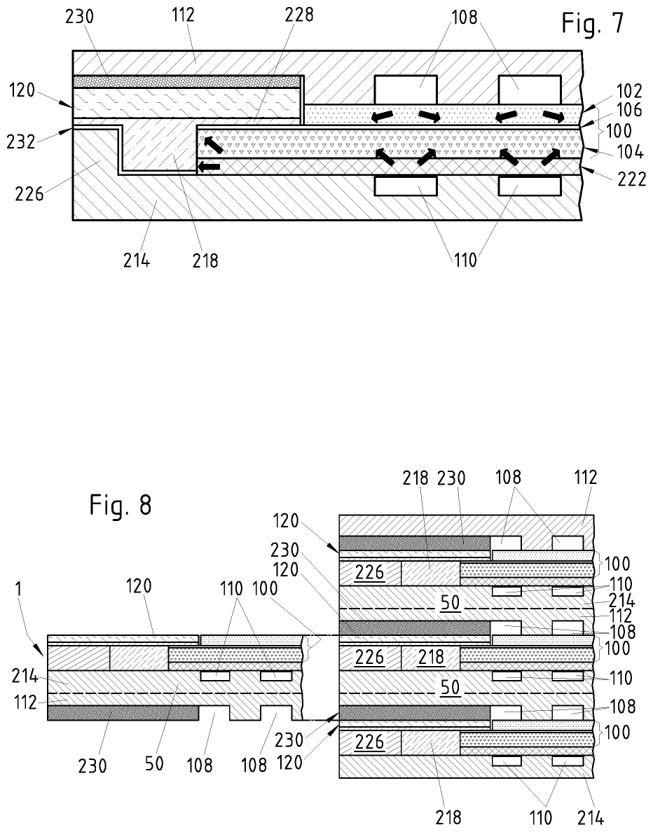

The planar arrangements forming the stack shown in FIG. 8 correspond to the same seventh embodiment also shown in FIG. 7. It should be understood however that any embodiment of the invention can be adapted to form the stacking units of a stack. Conversely, the high temperature planar electrochemical cell of any one of the planar arrangements illustrated in FIGS. 1 to 7 can also function on its own as an individual electrochemical reactor. In this second case, the two interconnects both belong to the one and only SOFC. In this second case, an essential role played by the interconnects is that of current collectors.

Now referring to FIG. 1 in particular, it can be observed that a contacting layer 122 is intercalated between the anode 104 and the surface of the second interconnect 114. The contacting layer 122 can be implemented for instance in the form of a layer of metal mesh that is arranged so as to cover the surface of the interconnect at least in the electrochemically active region of the fuel cell. As is known in the art, providing an additional layer between the anode and the neighboring interconnect allows for greatly reducing the electrical resistance of the contact interface between the anode 104 and the interconnect 114. Accordingly, the present description refers to the additional layer 122 as being a contacting layer.

As is often the case in an SOFC, in the embodiment illustrated in FIG. 1, the cathode 102, the anode 104 and the solid electrolyte 106 are made out of ceramics, and the interconnects 112, 114 are made from an electrically conductive metal material; In the present example, a Cr—Fe alloy. A single SOFC cell like the illustrated one can be typically only a few millimeters thick.

The ceramics used in the SOFC do not become sufficiently electrically and ionically active until they reach a very high temperature and as a consequence SOFC stacks usually have to run at temperatures above 500° C. Furthermore, in order to preserve the metallic components, the interconnects in particular, SOFC stacks should run at temperatures below 1,000° C. When the temperature has reached its operating value (between 500 C and 1,000° C.), the process of reduction of the oxidizing gas (usually oxygen) into ions begins at the cathode 102. These anions can then diffuse through the solid oxide electrolyte 106 to the anode 104 where they can form an oxide with the combustible gas (the fuel). In the most common case, this electrochemical oxidation reaction gives off a water byproduct as well as two electrons. The electrons then flow through an external circuit (of which, only the interconnects 112, 114 are shown) where they can do work. The external circuit then leads the electrons back to the cathode, and the cycle can repeat itself. Under typical operating conditions, the voltage difference between the anode and the cathode of an individual fuel cell is around 1±0.5 Volts. In order to achieve a higher output voltage, it is known to connect a plurality of such cells in series to form what is known as an “SOFC stack.

Still referring to the cross-section of FIG. 1, one can observe that a two-component sealing member (generally designated by the reference number 116) is arranged on the side of the high temperature electrochemical cell. Although it is not shown explicitly, it will be understood that, according to the illustrated example, the sealing member 116 actually extends at the periphery of the electrochemical cell, along its entire circumference (or at least a major part of its circumference). According to the present invention, the sealing member is hybrid and comprises a first and a second sealant. The first sealant is a glass component or glass layer 118. The second sealant consists of a mica sheet 120 that covers the glass layer. It should be understood that according to alternative embodiments of the invention, the mica sheet 120 could be replaced by a sheet of any other type of ceramic flake or fiber paper that a person skilled in the art would consider to be suited for the present purpose.

FIG. 1 further shows that, in this first embodiment, the glass layer 118 is formed over the periphery of the inner (or upper) surface of the second interconnect 114, and that it is arranged alongside the edge of the solid electrolyte layer 106, adjacent to it. It can further be observed in FIG. 1 that the top surface of the glass layer 118 is substantially flush with the top surface of the solid electrolyte layer 106, and that the mica sheet 120 that covers the glass layer also covers the peripheral part of the solid electrolyte layer. Furthermore, the mica sheet borders the edge of the cathode layer 102, in such a way as to substantially surround the cathode electrode. One advantage of the arrangement that has just been described is that the presence of the mica sheet helps to keep the oxidizing gas away from the glass component 118, and significantly limits the number of oxidizing gas molecules that can reach the glass component and diffuse into it.

Still referring to FIG. 1, it can further be observed that the extension of the metal mesh forming the contacting layer 122 that covers the surface of the interconnect 114 is limited to the portion of the interconnect that directly faces the cathode 102. One will therefore understand that the part of the solid electrolyte layer 106 that is covered by the mica sheet 120 is not really part of the region of the fuel cell that is electrochemically active.

FIG. 2 is a schematic partial cross-sectional view of an electrochemical cell according to a second embodiment that is slightly different from the previously described first embodiment. As already stated, elements of FIG. 2 that are the same, or that are functionally equivalent, are designated by the same reference number as in FIG. 1. According to this second embodiment, the first interconnect 212 comprises a peripheral portion 224 that is shaped so as to press the mica sheet 120 against the glass component 118 of the sealing member 116. The applicant has discovered that, comparatively to an uncompressed mica sheet, this arrangement that presses the mica sheet against the glass component improves the sealing functionality of the sealing member, even at low compression.

FIG. 3 is a schematic partial cross-sectional view of an electrochemical cell according to a third embodiment that is slightly different from the previously described second embodiment. According to this third embodiment, the contacting layer 222 extends further towards the periphery of the electrochemical cell, in such a way that the metal mesh can come into direct contact with the glass component 118 of the sealing member 116. A first advantage of this arrangement is that it allows more combustible gas to be supplied to the outer periphery of the anode, which protects the cell edge against local oxidation and mechanical failure. A second advantage is related to the problem of pore formation. Indeed, as previously mentioned, pore formation is particularly problematic in glass seals that are exposed to dual atmosphere, i.e. exposed to oxidant on one side and exposed to fuel on the other side. The reason for this, is possibly that steam can be formed by the chemical reaction of hydrogen that diffuses through the glass from the fuel side of the sealant, and oxygen gas that diffuses from the oxidant side. Hydrogen diffuses through glass faster than oxygen, and by increasing the amount of hydrogen diffusing through the glass, it is possible to “push back” the location where the formation of steam mainly occurs. One will therefore understand that having the metal mesh be in direct contact with the glass component 118 of the sealing member 116 will, in particular, provide protection of the edge of the high temperature electrochemical reaction against local oxidation and mechanical failure.

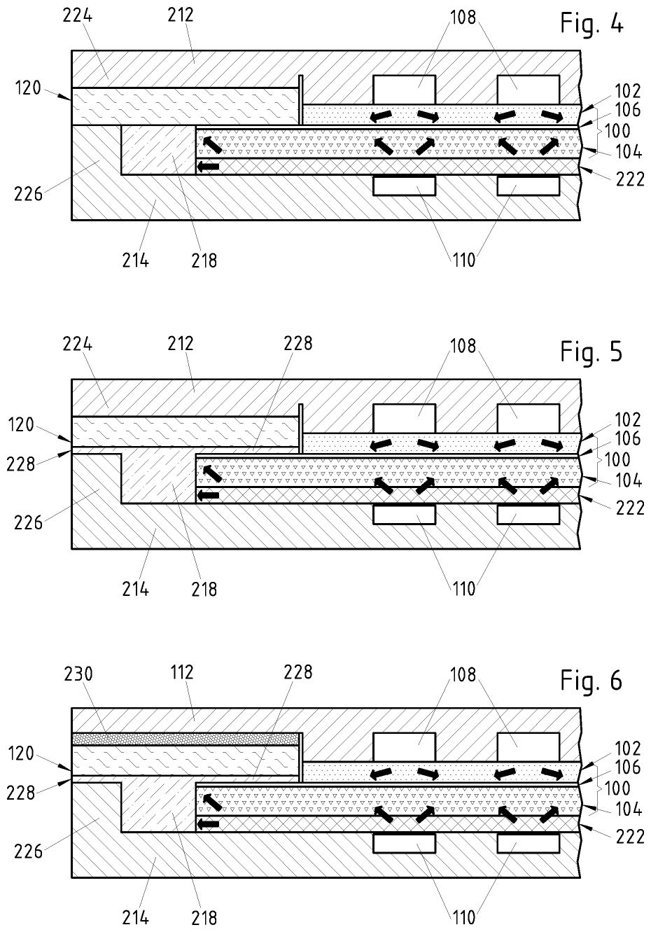

FIG. 4 is a schematic partial cross-sectional view of an electrochemical cell according to a fourth embodiment that is slightly different from the previously described third embodiment. According to this fourth embodiment, a periphery of the upper surface of the second interconnect 214 extends outwards beyond the glass component 218. As shown in FIG. 4, this peripheral part of the second interconnect comprises a peripheral protruding part 226 that plays the role of a rim surrounding the glass component 218. Alternatively, the peripheral part of the second interconnect can carry a peripheral protruding part 226 that is attached to its surface. In this case, it is the peripheral protruding part that forms a rim around the glass component (for example, the protruding part can be in the form of a plate or a wire that is attached to the surface of the interconnect 214).

An advantage of the protruding part 226 of the present example is that it can constrain the glass component 218 during curing. In other words, it serves as a barrier to prevent the glass from flowing out when the viscosity of the glass component is low. Another advantage is that the protruding part 226 can itself improve the sealing functionality by operating as an additional barrier against gas flow. Furthermore, according to a preferred variant of the fourth embodiment, the top surface of the protruding part 226 is located in the same plane as the top surface of the solid electrolyte 106, and the mica sheet 120 also covers the protruding part. In this way, the protruding part can provide additional mechanical support for the mica sheet 120. An advantage of this arrangement is that it reduces to a minimum the stress and the strain on the mica sheet.

It should be understood however that, according to possible alternative embodiments (not shown), the upper surface of the second interconnect can extend outwards beyond the glass component without carrying any protruding part. Furthermore, according to some of these embodiments, the sheet of ceramic fiber or flake paper extends outwards beyond the glass component, in such a way to cover also the periphery of the upper surface of the second interconnect.

FIG. 5 is a schematic partial cross-sectional view of an electrochemical cell according to a fifth embodiment that is slightly different from the previously described fourth embodiment. According to this fifth embodiment, a thin layer of glass 228 is provided between the mica sheet 120 and the mating sealing parts (the top surface of the protruding part 226 and the top surface of the solid electrolyte 106). A particularly efficient way to form the thin glass layer 228 is to first deposit the layer of glass on the mica sheet 120 by spraying, screen printing, stencil printing, rolling, painting, brushing, dip coating, or any other method known to the person skilled in the art, and then to place the mica sheet coated with the glass over the surfaces it is intended to cover (the top surface of the protruding part 226, the top surface of the glass component 218 and the top surface of the solid electrolyte 106). Another simple way to form the thin glass layer 228 is to provide slightly more glass than is needed for forming the glass component 218. Upon curing, the excess glass will flow between the mica sheet and the outer periphery of the top surface of the solid electrolyte. The excess glass will flow as well between the mica sheet and the top of the protruding part 226. The mica sheet is not fully dense. Therefore, the glass flow is viscous and the mica sheet attracts glass to adhere to its surface. Furthermore, due to capillary forces, the glass penetrates between the mica sheet and the mating surfaces.

The applicant has found that the mica makes the glass less prone to mechanical failure. In particular, the mica sheet can accept large displacement without breaking. The presence of the mica sheet can thus prevent tensile stress acting on the glass.

FIG. 6 is a schematic partial cross-sectional view of an electrochemical cell according to a sixth embodiment of the invention that is slightly different from the previously described fifth embodiment. According to this sixth embodiment, the electrochemical cell comprises a spacer 230 arranged so as to press the mica sheet 120 against the glass component 218. The spacer is itself pressed against the mica sheet by a peripheral portion of the first interconnect 112. The spacer can be made from a rigid material (e.g. metal or ceramic), but it is preferably a mechanically compliant part. It can for example be made from a compliant material like felt. Or else, the spacer can itself be a complex compliant structure (for example, an assembly of corrugated metal and felt). This allows for tuning the compressive force that acts on the active part of the electrochemical cell. The applicant has discovered that it is beneficial that the compressive force that acts on the sealing member is less than a corresponding compressive force that acts on the active part of the electrochemical cell. An advantage of this arrangement is that it allows to maintain the electrical contact between the interconnect and the solid oxide electrochemical cell in a better way. Another advantage is that the seals do not deteriorate as fast, as less mechanical force acts on them.

FIG. 7 is a schematic partial cross-sectional view of an electrochemical cell according to a seventh embodiment that is slightly different from the previously described sixth embodiment. According to this seventh embodiment, a protective coating (232) is provided between the glass component (218) and the second interconnect (214). An advantage of providing a protective coating on the metal surfaces of the interconnect that are in contact with the glass component is that the lifetime of the sealing member can be increased. The protective coating can be any dense coating made of metal, metal alloy, ceramic, glass, any composite material, or any other material known to the person skilled in the art, which is stable in the operative conditions and improves the stability of the sealing material.

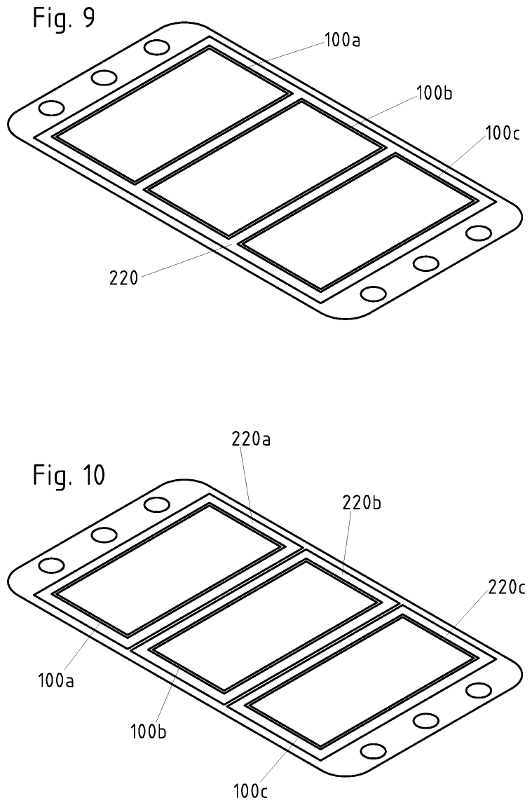

FIGS. 9 and 10 are perspective views from above of two exemplary planar arrangements according to the invention. The planar arrangements are illustrated with the first interconnect removed, in such a way as to show the CAE-units, as well as circumferential sealing members and sealing-member strips arranged around and between the CAE-units. The sealing member strips are arranged between two CAE-units and they are connected at each end with another sealing member in such a way as to prevent either the leakage of the oxidizing gas or the combustible gas to the environment or the mixing of the two gases. As was already the case with the circumferential sealing members described in relation FIGS. 1 to 7, the sealing-member strips of the present example comprise a glass component that is covered by a sheet of ceramic flake or fiber paper, preferably by a sheet of mica.

As can be seen, the planar arrangements of FIGS. 9 and 10 comprise three CAE-units. According to the particular embodiment shown in FIG. 9, a single mica sheet 220 comprises three rectangular cut-outs above the CAE-units 100a, 100b and 100c. As can be seen, the mica sheet extends substantially across the entire planar arrangement, except in the vicinity of the feeding and exhaust ducts. According to the particular embodiment shown in FIG. 10, each CAE-unit is surrounded by an individual mica frame 220a, 220b and 220c. Each one of the three frames preferably consists of a rectangular mica sheet comprising a large rectangular cut-out for the CAE-unit. It should be understood however that, on the one hand, the integral mica frame could be replaced by a frame made out of four mica strips, and on the other hand, that the mica sheet could be replaced by any other kind of ceramic paper that a person skilled in the art would consider to be suited for the present purpose.

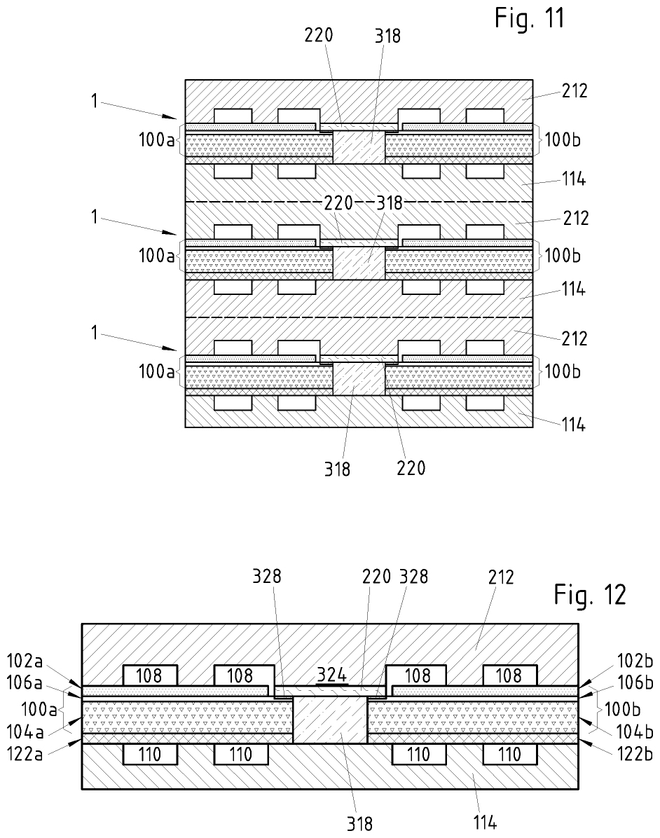

FIGS. 11 to 18 are schematic partial cross-sectional views of planar arrangements constituting a second series of exemplary embodiments of the invention. The distinctive common feature of the embodiments from this second series is that instead of each comprising one single CAE-unit, the planar arrangements each comprise multiple CAE-units sandwiched between the same two interconnects, in a so-called multiple cell arrangement. The partial cross-sectional views of FIGS. 12 to 18 each show portions of two neighboring CAE-units, as well as a sealing member arranged so as to insulate one CAE-unit from the other. As was already the case with the first seven embodiments, it should be understood that any one of the individual planar arrangements illustrated in FIGS. 12 to 18 can constitute an individual stacking element from a stack comprising many such elements connected together. The appended

FIG. 11 contains a partial cross-sectional view of such a stack. The partial view shows three identical planar arrangements 1 piled one over the other. In this illustrated stack, each interconnect is shared by two neighboring planar arrangements. However, it should be understood that, conversely, the high temperature planar electrochemical cells of any one of the planar arrangements illustrated in FIGS. 12 to 18 can also function on their own as individual electrochemical reactors. In this second case, the two interconnects both belong to the one and only planar arrangement. According to the illustrated embodiments, the interconnects are made from an electrically conductive metal material; preferably a Cr—Fe alloy. As they are electrically conductive, the interconnects can also serve as current collectors for the CAE-units.

The planar arrangements of FIGS. 12 to 18 each include two CAE-units (each referenced 100a and 100b respectively) comprising a first electrode layer or cathode (102a and 102b), a second electrode layer or anode (104a and 104b), and a solid electrolyte (106a and 106b) sandwiched between the anode and the cathode. As can be seen, the CAE-units are themselves sandwiched between the two same interconnects (the first interconnect is numbered 112 or 212 and the second interconnect is numbered 114 or 214). The planar arrangements of FIGS. 12 to 18 further comprise a first flow field 108 for an oxidizing gas, and a second flow field 110 for a combustible gas. It can also be observed that contacting layers 122a, 122b are intercalated between the anodes 104a 104b and the second flow field 110 at the surface of the second interconnect. The contacting layers 122a, 122b can each be implemented in the form of a layer of metal mesh that is arranged so as to cover the surface of the second interconnect at least in the regions facing the electrochemically active parts of the CAE-units.

Referring more specifically to FIG. 12, it can be observed that in this eighth embodiment, a glass layer 318 is formed over the second interconnect 114 and fills a gap between the CAE-units 100a and 100b. Although no such coating is shown in FIG. 12, it should be understood that a protective coating can further be provided between the glass layer 318 and the upper surface of the second interconnect 114. The glass layer extends upwards from the second interconnect 114 to a level slightly above the level of the two interfaces between the cathodes and the solid electrolytes of the CAE-units. According to the invention a mica sheet or strip 220 covers the glass layer 318. The mica layer also covers a lateral portion of each one of the two solid electrolyte layers 106a and 106b. It can further be observed that a thin layer of glass 328 is provided between the mica sheet 220 and the top surface of the lateral portions of the solid electrolytes. It should also be noted that the first interconnect 212 comprises a protruding portion 324 that is shaped so as to press the mica sheet 220 against the glass component 318.

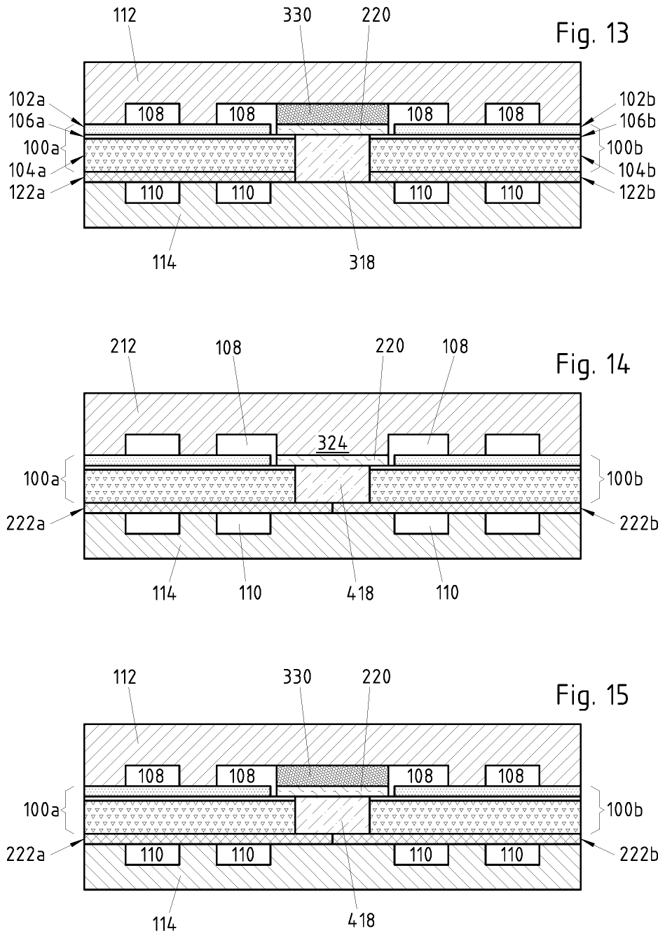

FIG. 13 is a schematic partial cross-sectional view of a planar arrangement according to a ninth embodiment that is slightly different from the previously described eighth embodiment. As already stated, elements of FIG. 13 that are the same or that are functionally equivalent are designated by the same reference number as in the other figures. A significant difference that can be observed in FIG. 13, is that a spacer 330 is arranged so as to press the mica sheet 220 against the glass component 318. The spacer is itself pressed against the mica sheet by a portion of the first interconnect 112. The spacer 330 can be made from a rigid material (e.g. metal or ceramic), but it is preferably a mechanically compliant part. It can for example be made from a compliant material like felt. Or else, the spacer can itself be a complex compliant structure (for example, an assembly of corrugated metal and felt).

FIG. 14 is a schematic partial cross-sectional view of a planar arrangement according to a tenth embodiment of the invention. As can be observed, the embodiment illustrated in FIG. 14 does not comprise the spacer shown in FIG. 13. All the same, the tenth embodiment is also slightly different from the embodiment of FIG. 12. In particular, as can be observed, portions of the contacting layers 222a, 222b extend under the glass layer 418. In other words, according to the presently described embodiment, the glass layer 418 is formed over the contacting layers 222a, 222b in such a way that the glass layer 418 covers parts of both contacting layers. As shown in FIG. 14, the contacting layers 222a and 222b are adjacent and meet each other under the glass layer. It should be understood however that according to an alternative variant of the same embodiment, one single integral contacting layer 222 could extend under the anodes 104a, 104b of both CAE-units 100a and 100b.

FIG. 15 is a schematic partial cross-sectional view of a planar arrangement according to an eleventh embodiment that is slightly different from the previously described tenth embodiment. Indeed, a spacer 330 is arranged so as to press the mica sheet 220 against the glass component 418. The spacer is itself pressed against the mica sheet by a portion of the first interconnect 112. As already explained in relation to FIG. 13, the spacer 330 can be made from a rigid material (e.g. metal or ceramic), but it is preferably a mechanically compliant part. It can for example be made from a compliant material like felt. Or else, the spacer can itself be a complex compliant structure (for example, an assembly of corrugated metal and felt).

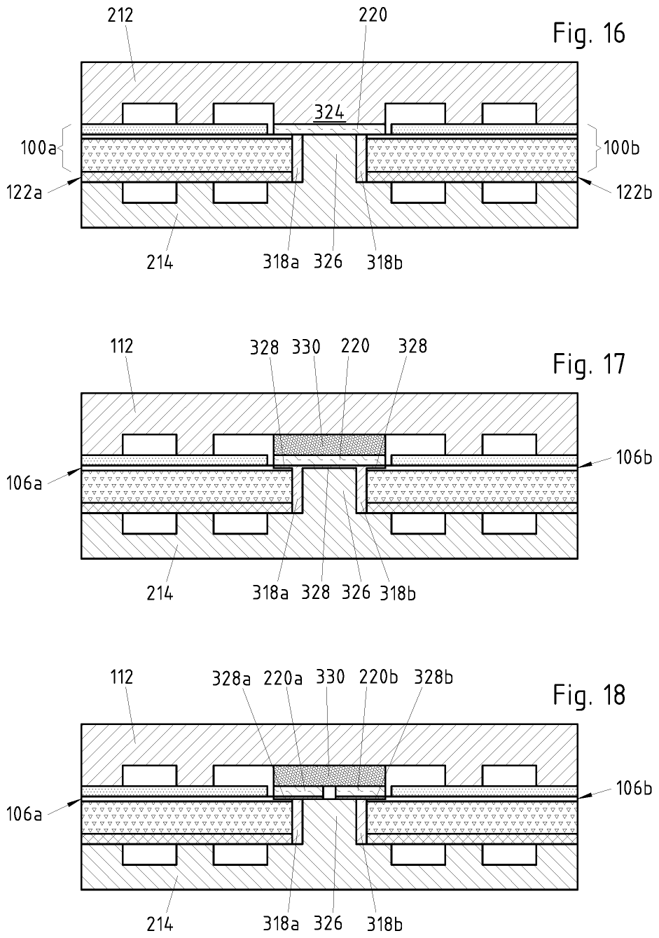

FIG. 16 is a schematic partial cross-sectional view of a planar arrangement according to a twelfth embodiment that is slightly different from the previously described eighth embodiment. According to the embodiment illustrated in FIG. 16, the second interconnect 214 can comprise an integral protruding rib 326 that plays the role of a barrier between the CAE-units 100a and 100b. Alternatively, the second interconnect can carry the protruding rib 326 attached to its surface. According to the illustrated example, two glass layers 318a, 318b each fill a gap between one of the CAE-units 100a, 100b and the protruding rib 326. According to a preferred variant of the twelfth embodiment, the top surface of the protruding rib 326 is located in the same plane as the top surfaces of the solid electrolytes 106a, 106b, and the mica sheet 220 covers both glass layers, a lateral portion of each one of the two solid electrolyte layers, and the protruding rib. The protruding rib therefore provides additional mechanical support for the mica sheet 220.

FIG. 17 is a schematic partial cross-sectional view of a planar arrangement according to a thirteenth embodiment that is slightly different from the previously described twelfth embodiment. Indeed, a spacer 330 is arranged so as to press the mica sheet 220 against the glass components 318a, 318b. The spacer is itself pressed against the mica sheet by a portion of the first interconnect 112. It can further be observed that a thin layer of glass 328 is provided between the mica sheet 220 and the top surface of the protruding rib 326, as well as between the mica sheet and the top surfaces of the lateral portions of the solid electrolytes 106a and 106b. One should note that such a thin glass layer is preferably also present in the previously discussed twelfth embodiment.

FIG. 18 is a schematic partial cross-sectional view of a planar arrangement according to a fourteenth embodiment that is slightly different from the previously described thirteenth embodiment. Indeed, FIG. 18 shows a pair of mica sheets 220a, 220b, each mica sheet covering one of the glass layers 318a, 318b. Actually, according to this fourteenth exemplary embodiment, the CAE-units 100a, 100b are each surrounded by an individual mica frame 220a, 220b, as depicted in the perspective view of FIG. 10. However, the partial view of FIG. 16 shows only the portions of the two mica frames that are located in between the CAE-units. Still referring to FIG. 18, one can observe that the mica frames 220a, 220b each cover a portion of the protruding rib 326, one of the glass layers 328a, 328b and a lateral portion of one of the two solid electrolyte layers 106a, 106b. Finally, as was already the case in the previous embodiments, a thin layer of glass 328a, 328b is provided between each one of the mica sheets 220a, 220b and the top surface of the protruding rib 326, as well as between each mica sheets and the top surface of the lateral portion of one of the solid electrolytes 106a and 106b.

It will be understood that various alterations and/or improvements evident to those skilled in the art could be made to the embodiments that forms the subject of this description without departing from the scope of the present invention defined by the annexed claims. In particular, a thin layer of glass is preferably always present between the mica sheet of a sealing member according to the invention and any portion of the top surface of a solid electrolyte that is covered by the mica sheet in a planar arrangement according to the invention. However, according other possible embodiments of the invention, this thin layer of glass could be dispensed with. In this case, the top surface of the glass layer is preferably substantially flush with the top surface of any solid electrolyte layer, a portion of which is covered by the mica sheet.

1. A planar arrangement comprising at least one CAE-unit (100; 100a, 100b), both a first flow field (108) for an oxidizing gas and a first interconnect (112; 212) arranged on a first side of the CAE-unit, both a second flow field (110) for a combustible gas and a second interconnect (114; 214) arranged on the other side of the CAE-unit, said at least one CAE-unit (100; 100a, 100b) comprising a first electrode layer (102; 102a, 102b), a second electrode layer (104; 104a, 104b), and a solid electrolyte (106; 106a, 106b) sandwiched between the first and the second electrode layers, the first electrode layer forming the first side of the CAE-unit and the second electrode layer forming the other side, wherein the planar arrangement further comprises a circumferential sealing member (116) provided to prevent either the leakage of the oxidizing gas or the combustible gas to the environment or the mixing of said two gases, characterized in that the sealing member (116) comprises a glass component (118; 218; 318; 318a, 318b) bound to the upper surface of the second interconnect (114; 214), and a sheet (120; 220) of ceramic flake or fiber paper arranged so as to cover a side of the glass component facing the first interconnect (112; 212).

2. The planar arrangement of claim 1, wherein the glass component (118; 218; 318; 318a, 318b; 418) is arranged adjacent to an edge of the solid electrolyte (106; 106a, 106b), and the sheet (120; 220) of ceramic flake or fiber paper covers both the glass component and an outer part of the solid electrolyte.

3. The planar arrangement of claim 1 or 2, wherein a periphery of the upper surface of the second interconnect (114; 214) extends outwards beyond the glass component (118; 218) of the circumferential sealing member, and wherein the sheet (120) of ceramic flake or fiber paper extends outwards beyond the glass component over the periphery of the upper surface of the second interconnect.

4. The planar arrangement of claim 2 or 3, wherein a thin layer of glass (228; 328) is provided between the sheet (120; 220) of ceramic flake or fiber paper and the outer part of the solid electrolyte (106; 106a, 106b) and/or between the sheet of ceramic flake or fiber paper and the periphery of the upper surface of the second interconnect.

5. The planar arrangement of any one of the preceding claims, wherein the surface of the second interconnect (214), to which the glass component (218, 228) is bound, is pretreated with a protective coating (232) provided to ensure adhesion and durability of the glass.

6. The planar arrangement of any one of the preceding claims, wherein the first interconnect (212) comprises a peripheral portion (224) that is shaped so as to press the sheet (120) of ceramic flake or fiber paper against the glass component (118; 218) of the circumferential sealing member (116).

7. The planar arrangement of any one of claims 1 to 5, wherein a spacer (230; 330) is provided between the sheet (120; 220) of ceramic flake or fiber paper and the first interconnect (112), the spacer being designed in such a way as to press the sheet of ceramic flake or fiber paper against the circumferential sealing member (116) with a determined compressive force.

8. The planar arrangement of claim 7, wherein the determined compressive force is less than a corresponding compressive force that acts on the at least one CAE-unit (100; 100a, 100b).

9. The planar arrangement of any one of the preceding claims, wherein the second interconnect (214) carries or comprises a protruding part (226; 326) that forms a rim arranged outwards of the glass component (218; 318) of the circumferential sealing member (116) and provides backing thereto.

10. The planar arrangement of claim 9, wherein the top surface of the protruding part (226; 326) is substantially aligned with the top surface of the solid electrolyte (106; 106a, 106b), and wherein the sheet (120; 220) of ceramic flake or fiber paper of the circumferential sealing member (116) extends over the protruding part, in such a way that the protruding part provides mechanical support for the sheet of ceramic flake or fiber paper.

11. The planar arrangement of any one of the preceding claims, comprising a porous contacting layer (122; 222; 122a, 122b; 222a, 222b) between the second interconnect (114; 214) and said at least one CAE-unit (100; 100a, 100b), and wherein an outer edge of the porous contacting layer is adjacent with the glass component (118; 218) of the circumferential sealing member.

12. The planar arrangement of any one of the preceding claims, wherein it comprises a single CAE-unit (100) sandwiched between the first interconnect (112; 212) and the second interconnect (114; 214), and wherein the circumferential sealing member (116) surrounds the CAE-unit.

13. The planar arrangement of any one of claims 1 to 11, wherein it comprises a plurality of CAE-units (100a, 100b) sandwiched between the first interconnect (112; 212) and the second interconnect (114; 214), and wherein the circumferential sealing member (116) surrounds at least one of the CAE-units of the plurality of CAE-units.

14. The planar arrangement of claim 13, wherein the circumferential sealing member (116) encloses every CAE-unit in the plurality of CAE-units (100a, 100b).

15. The planar arrangement of claim 13, wherein it comprises a plurality of circumferential sealing members, each one of said plurality of circumferential sealing members enclosing at least one CAE-unit.

16. The planar arrangement according to claims 11 and 15, wherein the porous contacting layer (122a, 122b) is discontinuous and does not extend between two circumferential sealing members.

17. The planar arrangement of claim 13, wherein the circumferential sealing member encloses at least two CAE-units of the plurality of CAE-units (100a, 100b), and wherein it comprises at least one sealing member strip arranged in-between said two CAE-units, in such a way as to prevent either the leakage of the oxidizing gas or the combustible gas to the environment or the mixing of said two gases, and wherein the sealing member strip comprises a glass strip component (318; 418), and a sheet (220) of ceramic flake or fiber paper arranged so as to cover a side of the glass strip component facing the first interconnect (112; 212).

18. The planar arrangement of claim 17, wherein the glass strip component (318; 418) is bound either to the upper surface of the second interconnect (114; 214) or to the porous contacting layer (122a, 122b).

19. The planar arrangement of claim 18, wherein the glass strip component (318; 418) is bound to the upper surface of the second interconnect (114; 214), and wherein the surface of the second interconnect (214), to which the glass strip component (318, 418) is bound, is pretreated with a protective coating provided to ensure adhesion and durability of the glass.

20. The planar arrangement of any one of claims 17, 18 and 19, wherein the glass component (318; 418) is arranged adjacent to an edge of at least one of the solid electrolyte layers (106a, 106b), and the sheet (220) of ceramic flake or fiber paper covers both the glass component and an outer part of the solid electrolyte layer.

21. The planar arrangement of any one of claims 17 to 20, wherein the lower side of the first interconnect (212) comprises a ridge (324), the surface of which is shaped so as to press the sheet (220) of ceramic flake or fiber paper against the glass component (318; 418) of the sealing member strip.

22. The planar arrangement of any one of claims 17 to 20, wherein a spacer (330) is provided between the sheet (220) of ceramic flake or fiber paper of the sealing member strip and the first interconnect (112), the spacer being designed in such a way as to press the sheet of ceramic fiber or flake paper against the sealing member strip with a determined compressive force.

23. The planar arrangement of any one of the preceding claims, wherein said sheet of ceramic flake or fiber paper is a mica containing sheet.

24. The planar arrangement of claim 23, wherein the mica in the sheet of mica is in the form of flakes.
